(19) United States
(12) Patent Application Publication
(10) Pub. No.: US 2007/0190308 A1
(43) Pub. Date: Aug. 16, 2007

(54) Coating for metal surfaces, method for the production thereof and use thereof as a self-cleaning protective layer, particularly for the rims of automobiles

(76) Inventors: Stefan Brand, Hirschberg-Leutershausen (DE); Andreas Dierdorf, Hoffheim (DE); Hubert Liebe, Wiesbaden (DE); Andreas Wacker, Mannheim (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/591,623

(22) PCT Filed: Feb. 22, 2005
(86) PCT No.: PCT/EP05/01828

§ 371 Date: Nov. 29, 2006

(30) Foreign Application Priority Data
Mar. 4, 2004 (DE) 10 2004 011 213.4

(51) Int. Cl. B32B 5/16; B05D 7/00; B05D 3/02; B32B 9/04; B32B 15/04

(52) U.S. Cl. 428/323; 427/407.1; 427/372.2; 428/447; 428/450; 428/330; 428/331

(57) ABSTRACT

A coating for metal surfaces, consisting of
a.) optionally a scratch-resistant perhydropolysilazane base coat and b.) an upper protective coat containing at least one perhydropolysilazane of the formula (1) and photocatalytic titanium dioxide (I) 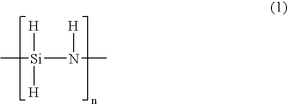 wherein n is a whole number and n is dimensioned in such a way that the measured such that the perhydropolysilazane has a number-average molecular weight of from 150 to 150 000 g/mol. Preferably, the thickness of the protective layer is at least 1 micrometre, more preferably 2 to 20 micrometres. The invention also relates to a method for the production of a coating, in addition to the use thereof as a self-cleaning protective layer, particularly for the rims of automobiles.

The present invention relates to a superhydrophilic, transparent, photocatalytically active coating for auto rims. The coating is based on polysilazanes, which are combined with photocatalytically active metal oxides.

The use of aluminum rims in automobile construction has increased greatly in recent years. On the one hand the lighter aluminum rims offer weight advantages over steel rims and so enable fuel savings, but the essential aspect is that aluminum rims are used above all for esthetic reasons, since they give the vehicle a high-value and refined appearance.

A disadvantage of aluminum rims is in particular their susceptibility to corrosion and their propensity to soiling. Moreover, scratches on the glossy surface of an aluminum rim are much more noticeable than on a steel rim. For this reason aluminum rims are provided at the end of the manufacturing operation with a coating, which is generally composed of a pretreatment of the aluminum (chromating or chromate-free), a primer, a pigmented base coat and, lastly, a clear coat. This complex coating is needed in order to ensure sufficient corrosion protection. In spite of the coating, corrosion causes problems, through the use, for example, of gritting salt in the winter. Finally brake dust which deposits on the aluminum rim over time likewise eats into the coating and can no longer be removed. Moreover, when snow chains are used, the aluminum rims are easily scratched. Another cause of scratches is the cleaning of the aluminum rims with abrasive tools, such as brushes or sponges. Also becoming more and more widespread are polished or bright-machined aluminum rims, whose surface consists of an esthetically appealing, glossy surface of pure aluminum, protected only by a thin clear coat, in order to retain the gloss of the rim. With this kind of rims the corrosion protection by means of the thin coating film, which additionally ought to be invisible to the human eye, is very difficult to bring about.

Another problem with auto rims is the ease with which they become soiled and the difficulty involved in cleaning the rim, depending on its geometry. Various types of auto rim are not completely clean even after a visit to the carwash. The sometimes complex geometry of the rims makes even cleaning by hand difficult. Since, however, the majority of car drivers place great value on having permanently clean rims, and wish to minimize the effort needed for their permanent cleanliness, a problem arises here which still awaits a solution.

WO 02/088269A1 describes the use of a perhydropolysilazane solution for producing hydrophilic, dirt-repellent surfaces. The description there includes that of use in the automobile sector (on the bodywork and the rims), and perhydropolysilazane solutions with a weight fraction of 0.3% to 2% are recommended. Example 1 there uses a highly dilute solution with a weight fraction of only 0.5% perhydropolysilazane, with which a very thin coating is obtained on steel, with a coat thickness of about 0.2 micrometer.

A coating so thin is first incapable of preventing scratching of the paint surface and is also incapable of ensuring sufficient corrosion protection or of preventing the eating-in of brake dust. Moreover, the thin coat is not enough to level the by relatively inhomogeneous clear coat and to produce a truly smooth, glassy surface readily amenable to cleaning.

The contact angles for water that could be achieved with the hydrophilic coating described above are situated at around 30°, which means that, when it rains or when the rims are cleaned with water, flat droplets are still formed. The relatively hydrophilic, glassy surface makes the rims easier to clean, but the coating has no self-cleaning effect.

The object on which the present invention was based was to develop a coating which exhibits a self-cleaning effect, is hard and scratch-resistant, and protects the aluminum rim against corrosion and against the burning-in of brake dust.

Self-cleaning surfaces can be obtained by coating with a photocatalytically active metal oxide, especially titanium dioxide in the anatase modification.

The self-cleaning effect is based essentially on the following mechanism: in photocatalysis, electrons from the valence band of the titanium dioxide are excited by light and cross over to the conduction band. The lifetime of these excited species is long enough to allow some of the electron holes and the electrons too to diffuse to the surface. There the electron holes abstract electrons from water molecules adhering to the surface, and the free electrons in the conduction band are transferred to oxygen molecules. This results in .OH radicals, which possess a very great oxidation potential (close to that of elemental fluorine), and superoxide anions (.O₂⁻), which likewise have a strongly oxidative effect.

The highly reactive .OH and .O₂⁻ species react with organic compounds (in the form of dirt particles, for example) to form water and carbon dioxide, so that the organic dirt is completely broken down.

As well as the photocatalytic effect, which causes oxidation of organic impurities on the surface of the TiO₂ particles, there is a further effect which is important for the production of self-cleaning surfaces: the effect of superhydrophilicity, whereby the surface is spontaneously wetted by water. This effect can be quantified by measuring the contact angle, with superhydrophilicity coming in at an angle <5°.

As a result of the combination of the two phenomena described, photocatalytically active surfaces exhibit a self-cleaning effect: on the one hand, dirt particles on the surface are destroyed (where they comprise organic material), and, additionally, the effective water wetting means that both dirt particles and the oxidation products are more easily washed from the surface. The superhydrophilic surface additionally provides an anti-deposit effect.

The photocatalytically active titanium dioxide has made inroads in Japan in particular as a coating material for a self-cleaning surface. Numerous patent applications and patents exist in this field.

However, owing to the strongly oxidative effect of the radicals formed, application is frequently restricted to coatings on inorganic substrates such as glass, ceramic, stone, etc.

For use as a coating on organic substrates such as plastics, varnishes and paints, etc., a protective coat is needed between the substrate and the titanium dioxide coat, and ought to meet the following criteria: it should be inorganic in nature, so that it is not destroyed itself by the photocatalytic effect of the titanium dioxide under sunlight exposure; it ought to have adequate adhesion both to the substrate and to the titanium dioxide coat; and it ought to be transparent, so as not to detract from the appearance of the substrate.

In the case of aluminum rims, it ought also to provide sufficient scratch protection and corrosion protection, and it ought to be capable of inexpensive application using the conventional coating techniques. To meet these conditions this inorganic protective coat must have a very high degree of crosslinking, so as to constitute a barrier to ions and gases.

Protective coats which possess the abovementioned properties can be produced, for example, from perhydropolysilazane (PHPS). On a variety of substrates PHPS forms very thin SiOₓ coats, which depending on the choice of reaction parameters may have a very high level of crosslinking.

The use of an SiOₓ protective coat obtained from PHPS between the substrate and a coat of photocatalytic titanium dioxide has been described in a number of patents.

Thus JP 2000 025 156 describes a self-cleaning protective coat consisting of a silica layer, produced from a polysilazane, and a further layer, comprising titanium dioxide as photocatalyst in a sol-gel matrix.

JP 2000 017 620 claims the same system for use as an antifog coating on traffic mirrors. As described above, superhydrophilic surfaces exhibit antifog properties since a film of water, rather than droplets, is formed.

JP 2000 017 619 describes a system comprising a PHPS protective coat and vapor-deposited photocatalytic titanium dioxide, or titanium dioxide in a siloxane matrix, for self-cleaning soundproof walls of polycarbonate and polymethyl methacrylate.

The systems described in the patent cited above are employed exclusively on polycarbonate, polymethyl methacrylate and glass. The pencil hardness of these coats, at 2-3H, moreover, is unsuitable for use on an aluminum rim. In all cases the titanium dioxide is applied either by vapor deposition or as a sol-gel matrix. No details are given of the effectiveness of the photocatalytic or self-cleaning effect.

In JP 11 035 887 a mixture of PHPS and photocatalytic titanium dioxide was applied to a glass substrate. This system is unsuitable for organic substrates, since in this case no inorganic protective coat is used.

In JP 11 227 091 as well no inorganic protective coat of PHPS is used, and so organic substrates cannot be used without being destroyed after a certain time.

JP 2000 053 920 and JP 2002 301 429 describe formulations comprising PHPS and photocatalytic titanium dioxide, the PHPS solids content of the formulation being between 0.1% and 5%. The use of these formulations is restricted to the coating of exterior facades.

JP 2003 170 060 describes a system composed of a PHPS primary coat and a photocatalytic titanium dioxide coat, the total coat thickness of this system being between 0.01 and 0.5 μm. Coat thicknesses of this kind are too low for scratch-resistant aluminum rims.

JP 2000 189 795 and JP 2000 191 960 likewise describe systems in which PHPS is used as the primary coat. Applied to this primary coat is a titanium dioxide coat which is embedded in a sol-gel matrix.

None of the photocatalytical systems indicated above is suitable for use as a self-cleaning coating for aluminum rims, since they all lack at least some of the requirements for that application. Either the coats are too thin and hence not scratch-resistant and also not corrosion-inhibiting, or no primary coat is used at all, so that after prolonged sun exposure the rim varnish would be destroyed by the photocatalytic action of the titanium dioxide, or the activity of the titanium dioxide is too low, since there is insufficient titanium dioxide at the surface and it is therefore unable to develop its photocatalytic action.

The object on which the present invention was based was to develop a coating which exhibits a self-cleaning effect, is hard and scratch-resistant, and protects the aluminum rim against corrosion and against the burning-in of brake dust.

Surprisingly it has now been found that with a perhydropolysilazane solution it is possible first of all to produce a sufficiently thick protective and barrier coat which is scratch-resistant and which prevents the corrosion of the aluminum rim and the chemical breakdown of the clear coat by the photocatalytic action of the titanium dioxide and also prevents the burning-in of the brake dust. The subsequently applied formulation comprising titanium dioxide (anatase) and perhydropolysilazane provides a self-cleaning effect and adheres outstandingly to the PHPS coat, owing to the chemical similarity.

The invention accordingly provides a coating for metal surfaces which is composed of

a.) optionally a scratch-resistant perhydropolysilazane base coat comprising a perhydropolysilazane of the formula (1) and

b.) an upper protective coat comprising at least one perhydropolysilazane of the formula (1) and photocatalytic titanium dioxide.

The perhydropolysilazane (PHPS), both in the base coat and in the protective coat, has the following formula (1)

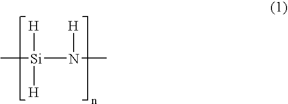

in which n is an integer and is measured such that the polysilazane has a number-average molecular weight of from 150 to 150 000 g/mol.

The protective coat (b) has a thickness of at least 1 micrometer, preferably from 2 to 20 micrometers, more preferably 3 to 10 micrometers, and ensures sufficient protection against corrosion and scratching.

The coating of the invention is especially suitable as a protective coat for auto rims, where it prevents the burning-in of brake dust on the rim and at the same time prevents the destruction of the organic clear coat by virtue of the second coat, which is applied additionally and comprises photocatalytic titanium dioxide.

This second coat comprises a mixture of PHPS of the formula (1) and nanoscale, photocatalytic titanium dioxide,

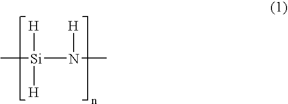

The nanoscale titanium dioxide is preferably of the anatase type and possesses a particle size of 0.001-0.5 μm. The ratio of perhydropolysilazane (based on the solids content of PHPS) to titanium dioxide in the photocatalytic coat is 1:0.01 to 1:100, preferably 1:0.1-1:50, more preferably 1:1-1:5.

Perhydropolysilazane exhibits very good adhesion to a very wide variety of substrates, including metals and ceramic surfaces, and also to polymeric materials such as, for example, plastics or varnishes.

The invention further provides a process for producing a self-cleaning coating for metal surfaces, in which first of all in a first, optional step

a.) a perhydropolysilazane solution comprising a catalyst and if desired one or more cobinders in a solvent is applied to the metal surface as a base coat and subsequently

b.) a further protective coat is applied to this base coat or to the metal surface directly, said protective coat comprising at least one perhydropolysilazane of the formula (1) and photocatalytic titanium dioxide 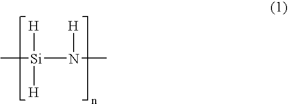
where n is an integer and is such that the perhydropolysilazane has a number-average molecular weight of from 150 to 150 000 g/mol.

The perhydropolysilazane solution can therefore be applied, for example, to a coated metal surface, e.g., to a coated aluminum rim, i.e., to the clear coat directly, in order to protect the rim additionally against scratching, corrosion or the burning-in of brake dust. There is also an increase in the gloss after the coating has been applied, as compared with the clear coat. Alternatively it is possible to do without the clear coat and to apply the perhydropolysilazane solution directly to the pigmented base coat, which allows a saving of one coating step.

In the case of polished or bright-machined aluminum rims it is also possible to use the perhydropolysilazane solution as the sole protective coat, replacing the clear coat normally employed.

Hence it is possible to produce a protective coat which is much less thick than conventional coats, in tandem with reduced material consumption and reduced solvent emission, said coat additionally having superior properties to the conventional coats.

Both the first and second protective coats are applied in solution. For that purpose the perhydropolysilazane is dissolved or dispersed in a solvent, with addition of a catalyst if desired. Particularly suitable solvents for the perhydropolysilazane formulation are organic solvents containing no water and no protic substances (such as alcohols or amines, for example). Such solvents are, for example, aliphatic or aromatic hydrocarbons, halogenated hydrocarbons, esters such as ethyl acetate or butyl acetate, ketones such as acetone or methyl ethyl ketone, ethers such as tetrahydrofuran or dibutyl ether, and also mono- and polyalkylene glycol dialkyl ethers (glymes), or mixtures of these solvents.

The concentration of perhydropolysilazane in the solvent for the base coat and the protective coat is in the range from 0.01 to 40% by weight, preferably in the range from 1% to 25% by weight.

As a further constituent, the perhydropolysilazane formulation may comprise catalysts, such as organic amines, fine metal particles or metal salts, or organic acids, which accelerate the formation of a silica film, or additives which influence, for example, formulation viscosity, substrate wetting, film formation or the evaporation behavior, or organic and inorganic UV absorbers or photoinitiators.

Suitable catalysts are N-heterocyclic compounds, such as 1-methylpiperazine, 1-methylpiperidine, 4,4′-trimethylenedipiperidine, 4,4′-trimethylene(1-methylpiperidine), diazobicyclo(2.2.2)octane and cis-2,6-dimethylpiperazine.

Further suitable catalysts are mono-, di- and trialkylamines such as methylamine, dimethylamine, trimethylamine, phenylamine, diphenylamine and triphenylamine, DBU (1,8-diazabicyclo(5.4.0)-7-undecene), DBN (1,5-diazabicyclo(4.5.0)-5-nonene), 1,5,9-triazacyclododecane and 1,4,7-triazacyclononane.

Further suitable catalysts are organic and inorganic acids such as acetic acid, propionic acid, butyric acid, valeric acid, maleic acid, stearic acid, hydrochloric acid, nitric acid, sulfuric acid, phosphoric acid, chloric acid and hypochlorous acid.

Further suitable catalysts are metal carboxylates of the formula (RCOO)NM of saturated and unsaturated, aliphatic or alicyclic C₁-C₂₂ carboxylic acids and metal ions such as Ni, Ti, Pt, Rh, Co, Fe, Ru, Os, Pd, Ir, and Al; n is the charge of the metal ion.

Further suitable catalysts are acetylacetonate complexes of metal ions such as Ni, Pt, Pd, Al and Rh.

Further suitable catalysts are metal powders such as Au, Ag, Pd or Ni with a particle size of from 20 to 500 nm.

Further suitable catalysts are peroxides such as hydrogen peroxide, metal chlorides and organometallic compounds such as ferrocenes and zirconocenes.

The coating may take place by means of processes such as are conventionally employed for surface coating. The process in question may be, for example, spraying, dipping or flow coating. Afterward there may be a thermal aftertreatment, in order to accelerate the curing of the coating. Depending on the perhydropolysilazane formulation used and catalyst, curing takes place even at room temperature, but can be accelerated by heating.

Because of the high reactivity of the perhydropolysilazane the coating cures in principle even at room temperature or below, but its curing can be accelerated by an increase in temperature. The maximum possible curing temperature depends essentially on the substrate to which the coating is applied. In the case of bright aluminum relatively high temperatures are possible, 180-200° C. for example. If the coating is applied to a coat which is already present (either base coat or clear coat), it is advisable to work at a lower temperature, so that the underneath coat does not soften, preferably at 25 to 160° C., more preferably at 80 to 150° C. Before the second protective coat is applied it is preferred to cure the base coat initially at from room temperature up to temperatures of 200° C., depending on the coating material.

The curing of the coating is also affected by the atmospheric humidity. At relatively high humidity curing takes place more rapidly, which can be an advantage; conversely, curing in an atmosphere with only low humidity, such as in a drying cabinet, entails a slow and uniform curing process. Curing of the coating of the invention can therefore take place at a relative atmospheric humidity of from 0 to 100%.

The base coat produced by means of the above-described perhydropolysilazane formulation itself alone already forms an easy-to-clean surface, owing to its hydrophilic character. The contact angles for water are around 300, and so drops which are already very flat are formed. This surface, however, does not have self-cleaning properties. It is scratch-resistant, protects against corrosion, adheres outstandingly to clear coat, base coat or polished aluminum, and presents an excellent barrier for the coat comprising photocatalyst that is to be applied subsequently. It also increases the gloss of the metal surface.

Over the above-described silica base coat there is then applied a second coat, comprising a photocatalyst. Typical photocatalysts are titanium dioxide (TiO₂), iron oxide (Fe₂O₃), tungsten oxide (WO₂), zinc oxide (ZnO), zinc sulfide (ZnS), cadmium sulfide (CdS), strontium titanate (SrTiO₂) and molybdenum sulfide (MOS₂), and doped species of the aforementioned photocatalysts. It is preferred to use titanium dioxide in the anatase modification.

So that this second coat too is transparent and does not adversely affect the original gloss of the substrate, the size of the titanium dioxide particles must be situated in a range of 0.001-0.5 μm. Particles of this kind are available commercially, either in powder form or in the form of dispersions.

There are a variety of methods for applying a photocatalytic coat of this kind to the silica coat. One method involves chemical vapor deposition (CVD). In this case a vapor of titanium dioxide particles is produced which then deposit on the respective surface. The coats are generally very thin (20-30 nm) and the process is technically demanding and expensive.

Titanium dioxide can also be produced in situ from a sol-gel system and applied to the surface together with this sol-gel matrix. For sol-gel systems a chemical step is needed first in each case and a thermal aftertreatment is required in order to allow these systems to cure. Another version, which is less expensive and easier to employ in comparison to the methods referred to above, involves mixing dispersed titanium dioxide with a perhydropolysilazane solution. A number of advantages arise in this case: there is no need for demanding and costly vapor deposition technology, there is also no need to carry out an additional synthesis step, and the compatibility of this formulation with the silica coat already present is excellent, since perhydropolysilazane is present in both cases. In this case, then, the perhydropolysilazane acts on the one hand as a binder for the titanium dioxide particles and on the other hand as an adhesion promoter for adhesion to the silica film. It is advisable to disperse the titanium dioxide particles in the same solvent in which the perhydropolysilazane as well is dissolved. The titanium dioxide dispersion and the perhydropolysilazane formulation are subsequently mixed in a defined ratio and the resultant dispersion is applied to the silica coat by dipping, flow coating or spraying. This second coat can cure at room temperature, although the curing operation can also be accelerated by heating.

The concentration of the perhydropolysilazane in a solvent is between 0.01% and 40%, preferably between 1% and 25%. The concentration of the titanium dioxide dispersion is between 0.01% and 70%, preferably between 0.5% and 30%. The solids ratio between perhydropolysilazane and titanium dioxide is 1:0.01 to 1:100, preferably 1:0.1 to 1:50. The concentration of the combined solutions of perhydropolysilazane and titanium dioxide is 0.01% to 50%.

In order to achieve an excellent photocatalytic or self-cleaning effect on the part of the coating it is necessary for the titanium dioxide content to amount with particular preference to 1-5 parts per part of PHPS. This ensures the presence in the topmost coat of a sufficient amount of reactive titanium dioxide particles which provide the photocatalysis and the superhydrophilicity.

The present invention further provides in particular for the use of the above-described coating as a self-cleaning protective coat for auto rims, especially aluminum rims.

### EXAMPLES

The perhydropolysilazanes used are products from Clariant Japan K.K. Solvents used are mixtures of xylene and Pegasol (designation NP) or di-n-butyl ether (designation NL). The solutions contain either amines, metals or metal salts as catalysts.

The titanium dioxide used comprises dispersions of nanoscale anatase in xylene.

In the examples below, parts and percentages are by weight.

The aluminum rims are standard commercial aluminum rims such as may be obtained via the auto accessory trade, or parts of these rims obtained by sawing from whole rims, or metal test panels consisting of appropriate material. Coating was carried out either by spraying with a standard commercial spray gun or by dipping in a standard commercial dipping apparatus.

The scratch resistance is determined by repeated loading (five back-and-forth strokes) with a 00-grade steel wool with a force of 3 N. The scratching is evaluated visually in accordance with the following scale: very good (no scratches), good (few scratches), satisfactory (distinctive scratches), adequate (severely scratched) and deficient (very severely scratched).

The adhesion of the coating was determined by cross-cut testing in accordance with DIN EN ISO 2409, the adhesion being on a scale from 0 (best score) to 4 (worst score).

The model substance used for determining the photocatalytic activity or self-cleaning effect was methylene blue, and its breakdown is monitored visually (disappearance of coloration).

### Example 1 (Coating of a Coated Aluminum Sheet with Base Coat and Clear Coat by Dipping)

A coated aluminum sheet which has been provided with a standard commercial pigmented base coat and a clear coat is immersed in a dipping apparatus which is filled with a 20% strength perhydropolysilazane solution in n-dibutyl ether (NL120A-20, containing palladium propionate as catalyst), and withdrawn from the apparatus at a speed of 120 cm/min. It is subsequently left in the air for about 10 minutes, for evaporation, and then dried at 80° C. for 60 minutes. The result is a clear, transparent and crack-free coating on the surface. The gloss of the sheet has increased by 5 gloss units as compared with the uncoated sheet. This coat is at least 2 μm thick.

Applied subsequently to this barrier coat is a mixture of 3.5 parts by weight of photocatalytic titanium dioxide in xylene and 1 part of weight of perhydropolysilazane in xylene (NL110-20, containing 4,4′-trismethylene(1-methylpiperidine)), which is applied likewise by dipping. The sheet is withdrawn from the dipping bath at a speed of 120 cm/min. It is left in the air for 10 minutes to evaporate. This gives a clear, transparent and crack-free coating which in the service test is much easier to clean than an uncoated aluminum sheet and, moreover, also has much less of a propensity to pick up dirt. After a number of days of sunlight exposure, a thin water film, rather than drops, is formed on the surface. When a methylene blue solution is applied to the sheet and the sheet is left to stand in sunlight, the blue color disappears after just a short time.

### Example 2 (Coating of a Polished Aluminum Sheet without Coating by Dipping)

In the case of a polished aluminum sheet without a clear coat, no perhydropolysilazane barrier coat was applied, since the substrate is composed not of an organic coating material but rather of polished aluminum, which is not attacked by the photocatalytic action of the titanium dioxide.

This sheet is immersed in a dipping apparatus which is filled with a mixture of 3.5 parts by weight of photocatalytic titanium dioxide in xylene and 1 part by weight of perhydropolysilazane in xylene (NL110-20, containing 4,4′-trismethylene-(1-methylpiperidine)) and is withdrawn at a speed of 120 cm/min. The sheet is subsequently left in air for about 10 minutes to evaporate and then dried at 80° C. for 60 minutes. This gives a clear, transparent and crack-free coating. This coating is scratch-resistant, protects against corrosion, prevents the burning-in of brake dust and is self-cleaning.

In the test the coated, polished aluminum sheet is much easier to clean than an aluminum sheet coated with clear coat, and also has much less of a propensity to pick up dirt. After a number of days of sunlight exposure a thin water film, rather than drops, is formed on the surface.

When a methylene blue solution is applied to the sheet and the sheet is left to stand in sunlight, the blue color disappears after just a short time.

### Example 3 (Coating of an Aluminum Rim by Spraying)

A standard commercial aluminum rim such as may be obtained via the automobile accessory trade is sprayed with a 20% strength perhydropolysilazane solution in n-dibutyl ether (NL120A-20, containing palladium propionate as catalyst). The rim is then left in the air for about 10 minutes, for evaporation, and subsequently dried at 80° C. for 60 minutes. This results in a clear, transparent and crack-free coating on the surface. The gloss of the coated rim has increased by 5 gloss units in comparison to the uncoated rim. This coat is at least 2 μm thick.

Subsequently a mixture of 3.5 parts by weight of photocatalytic titanium dioxide in xylene and 1 part by weight of perhydropolysilazane in xylene (NL110-20, containing 4,4′-trismethylene(1-methylpiperidine)) is applied to this barrier coat by spraying. Evaporation is allowed to take place for 10 minutes.

This gives a clear, transparent and crack-free coating which in the service test in comparison with an uncoated aluminum rim of the same make on the same vehicle is much easier to clean and also has much less of a propensity to pick up dirt. After a number of days of sunlight exposure a thin water film, rather than drops, is formed on the surface.

When a methylene blue solution is applied to the rim and the rim is left to stand in sunlight, the blue color disappears after just a short time.

### Example 4 (Coating of a Polished Aluminum Rim by Spraying)

A polished or bright-machined aluminum rim without clear coat was purchased from a rim manufacturer. In the case of this aluminum rim a perhydropolysilazane barrier coat was not applied, since the substrate is not composed of an organic coating but rather a polished aluminum, which is not attacked by the photocatalytic action of the titanium dioxide.

This rim is coated by spraying with a mixture of 3.5 parts by weight of photocatalytic titanium dioxide in xylene and 1 part by weight of perhydropolysilazane in xylene (NL110-20, containing 4,4′-trismethylene(1-methylpiperidine)).

The rim is subsequently left in the air for about 10 minutes, for evaporation, and then dried at 80° C. for 60 minutes. This gives a clear, transparent and crack-free coating. This coating is scratch-resistant, protects against corrosion, prevents the burning-in of brake dust, and is self-cleaning.

In the service test the coated, polished aluminum rim is much easier to clean in comparison to an uncoated aluminum rim of the same make on the same vehicle, and also has much less of a propensity to pick up dirt. After a number of days of sunlight exposure a thin water film, rather then drops, is formed on the surface. When a methylene blue solution is applied to the rim and the rim is left to stand in sunlight, the blue color disappears after just a short time.

1. A coating for metal surfaces composed of
a.) a scratch-resistant perhydropolysilazane base coat and
b.) an upper protective coat comprising at least one perhydropolysilazane of the formula (1) and photocatalytic titanium dioxide 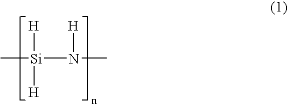
where n is an integer such that the perhydropolysilazane has a number-average molecular weight of from 150 to 150 000 g/mol.

2. The coating as claimed in claim 1, wherein the upper protective coat has a thickness of at least 1 micrometer.

3. The coating as claimed in claim 1, wherein the ratio of perhydropolysilazane to titanium dioxide in the upper protective coat is 1:0.01 to 1:100.

4. The coating as claimed in claim 1, wherein the titanium dioxide is in the anatase form.

5. The coating as claimed in claim 1, wherein the particle size of the titanium dioxide is in the range of 0.001-0.5 μm.

6. A process for producing a self-cleaning coating for a metal surface comprising in a first step
a.) applying a perhydropolysilazane solution comprising a catalyst and, and optionally one or more cobinders, in a solvent is to the metal surface as a base coat and in a second step
b.) applying a protective coat to the base coat or to the metal surface directly, the protective coat comprising at least one perhydropolysilazane of the formula (1) and photocatalytic titanium dioxide 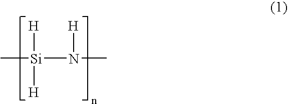
where n is an integer such that the perhydropolysilazane has a number-average molecular weight of from 150 to 150 000 g/mol.

7. The process as claimed in claim 6, wherein the concentration of perhydropolysilazane in the solvent for the base coat and the protective coat is in the range from 0.01% to 40% by weight.

8. The process as claimed in claim 6 wherein the first applying step and the second applying step further comprise curing the base coat and the protective coating to the metal surface and wherein the curing of the base coat and the curing of the protective coat takes place at room temperature to 200° C.

9. The process as claimed in claim 6, further comprising curing the base coat to the metal surface before applying the protective coat.

10. A self-cleaning protective coating for a metallic surface comprising the coating as claimed in claim 1.

11. The self-cleaning protective coating as claimed in claim 10, wherein the metallic surface is a rim.

12. The coating as claimed in claim 1, wherein the upper protective coat has a thickness of between 2 to 20 micrometers.

13. The coating as claimed in claim 1, wherein the upper protective coat has a thickness of between 3 to 10 micrometers.

14. The coating as claimed in claim 1, wherein the ratio of perhydropolysilazane to titanium dioxide in the upper protective coat is 1′:0.1-1:50.

15. The coating as claimed in claim 1, wherein the ratio of perhydropolysilazane to titanium dioxide in the upper protective coat is 1:1-1:5.

16. The self cleaning protective coating as claimed in claim 11, wherein the rim is an aluminum rim.

17. A metal having a self cleaning surface made in accordance with the process of claim 6.

18. The metal as claimed in claim 17, wherein the metal is in the form of a rim.

19. The metal as claimed in claim 17, wherein the rim is an aluminum rim.

20. A metal having a surface coated with the coating as claimed in claim 1.

21. The metal as claimed in claim 20, wherein the metal is in the form of a rim.

22. The metal as claimed in claim 21, wherein the rim is an aluminum rim.

23. A coating for metal surfaces consisting essentially of
a.) a scratch-resistant perhydropolysilazane base coat and
b.) an upper protective coat comprising at least one perhydropolysilazane of the formula (1) and photocatalytic titanium dioxide 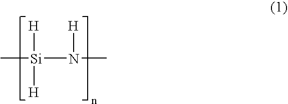
where n is an integer such that the perhydropolysilazane has a number-average molecular weight of from 150 to 150 000 g/mol.

24. A metal having a surface coated with the coating as claimed in claim 23.

25. The metal as claimed in claim 24, wherein the metal is in the form of a rim.

26. The metal as claimed in claim 25, wherein the rim is an aluminum rim.

27. A coating for metal surfaces comprising:
a.) a scratch-resistant perhydropolysilazane base coat and
b.) an upper protective coat comprising at least one perhydropolysilazane of the formula (1) and photocatalytic titanium dioxide 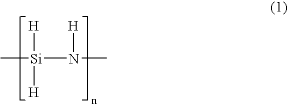
where n is an integer such that the perhydropolysilazane has a number-average molecular weight of from 150 to 150 000 g/mol.

28. A metal having a surface coated with the coating as claimed in claim 27.

29. The metal as claimed in claim 28, wherein the metal is in the form of a rim.

30. The metal as claimed in claim 29, wherein the rim is an aluminum rim.
